(19) United States
(12) Patent Application Publication
(10) Pub. No.: US 2025/0268379 A1
(43) Pub. Date: Aug. 28, 2025

(54) MOTORIZED MULTIMODAL SIMULATOR SYSTEM WITH CONVERTIBLE SEAT

(71) Applicant: UNW, Inc., Dix Hills, NY (US)

(72) Inventors: Gary De Sesa, Dix Hills, NY (US); David Galluzzo, Brewster, NY (US); Zachary Beauman, Levittown, NY (US); Antonio Marra, Bay Shore, NY (US)

(73) Assignee: UNW, Inc., Dix Hills, NY (US)

(21) Appl. No.: 18/858,551

(22) PCT Filed: Apr. 20, 2023
(86) PCT No.: PCT/US2023/065997

§ 371 Date: Oct. 21, 2024

Related U.S. Application Data
(60) Provisional application No. 63/346,648, filed on May 27, 2022.
(60) Provisional application No. 63/333,734, filed on Apr. 22, 2022.

(51) Int. Cl. A47C 3/20; A47C 4/28

(52) U.S. Cl. CPC A47C 3/20; A47C 4/28

(57) ABSTRACT

A convertible seat assembly comprising: a seat bottom having a longitudinal axis, a top surface, a bottom surface, a first side, and a second side; and first and second side components disposed on the first and second sides of the seat bottom, the first and second side components having first and second planar surfaces, wherein the first and second side components are configured to move between folded and unfolded position, wherein the first and second planar surfaces are substantially parallel to the top surface of the seat bottom when the first and second side components are in the folded position, wherein the first and second side components are adjacent the bottom surface of the seat bottom when in the unfolded position, wherein the first and second side components rotate up to one hundred eighty degrees around the longitudinal axis when moving between the folded and unfolded positions.

### FIELD OF INVENTION

The field relates to configurable multimodal simulator frame and platform systems for immersive multimodal simulation for use in education, entertainment, gaming and training that may be connected to computers, game consoles and similar devices in a wired or wireless manner.

### BACKGROUND

The operation of performance vehicles such as airplanes, cars, boats and motorcycles carries risk of injury. This risk increases significantly when operators of these vehicles do not have the training or experience to avoid dangerous situations. With experience and training, the risk of a crash and serious injury is greatly reduced. To receive proper training, operators of vehicles must be able to experience the full range of vehicle capabilities and emergency procedures. Whenever possible, the actual vehicle should not be used for such training due to the potential costs and inherent dangers associated with operating the vehicle with insufficient skill and precaution. Accordingly, computer simulators capable of providing realistic simulations of the full range of vehicle motions and capabilities are important tools, both for those seeking training and for those who wish to experience operation of a vehicle to which they may not have access.

High-performance computers have allowed significant advances in the realism of computer-generated imagery. For example, computer graphics have advanced to a point where it can be difficult to determine whether an image is computer-generated or real. These improvements have allowed for significant advances in how users interact with computers and computer software for applications such as education, training, gaming and entertainment. For example, virtual reality (“VR”) and augmented reality (“AR”) technologies interface with computers to provide three-dimensional and interactive graphics that can allow for simulation experiences that mimic real environments or situations. Simulation technology allows a user to begin to feel as though he or she is present in a situation, thus creating new memories, proficiencies, opportunities for growth, or experiences.

Computer simulations are most powerful when users are fully immersed in the virtual experience. Most VR and AR technologies provide only the visual and auditory components of a virtual experience. A typical VR apparatus comprises a head-mounted display apparatus to simulate racing a car on a racetrack; users can only see and hear this experience, they will not feel the motion of the car on the track, track conditions, wind, vibrations, or other factors that affect the realism of the experience. This incomplete sensory immersion leaves a user unable to experience the feeling of being in the car and living in the experience in a manner that disconnects the user from the real world.

Moreover, experiencing visual motion without physical motion can induce feelings of nausea leading users to avoid VR experiences. There have been many attempts to create fully immersive motion simulators and simulator frame and platform systems that provide users with physical motion that matches their visual perception. If physical sensations are not well synchronized to visual motion, this can lead to feelings of vertigo and nausea. Due to these limitations, most motion simulators are limited to hardware and software specialized for one kind of virtual experience.

For example, there are currently several car racing and driving motion simulators that comprise a VR apparatus or other display, a frame forming a car cabin, a slidably adjustable car seat for different sized drivers, and associated driving peripherals coupled with a computer. The peripherals of car driving simulators may include: a steering wheel; a manual gear shift; an emergency brake or handbrake; and accelerator, brake and clutch pedals positioned in front of the seat. Driving simulators may further comprise one or more electric motor assemblies providing physical motion for simulation, and a cabin large enough to house the peripherals and display. For car simulators to be immersive, the display, peripherals, seat, motors and frame are usually built and synced to work exclusively with driving software so that the visual and physical experiences of the simulation correspond.

Some vehicles must be ridden—such as motorcycles, jet skis, ATVs, and snow mobiles—and require a user to straddle and lean with the vehicle while riding. In many known examples, recreating these experiences in a virtual environment requires a specialized narrow frame and saddle seat that cannot be emulated in a typical car motion simulator in which the wide frame, bucket seat, required peripherals and movements are remarkably different and thus cannot provide a physically immersive experience. In one example, a motorcycle motion simulator is required to have hardware and software specific to an immersive motorcycle riding experience, allowing a rider to feel as though he or she is straddling and riding a real motorcycle. In addition to a VR apparatus or other display, a saddle seat that is fixed to an elongated narrow frame that allows a user to straddle the seat, and one or more electric motor assemblies that provide motion, a motorcycle simulator may comprise peripherals that include handlebars with throttle, clutch and brakes, shift and brake pedals positioned below a saddle seat. The display, peripherals, frame, seat, and motors are typically coupled with a computer and synched to work exclusively with specific motorcycle simulation software to replicate the experience and performance of a motorcycle.

Yet another example, flight motion simulators are different than both car and motorcycle simulators. These simulators typically comprise a cockpit frame large enough to house a VR apparatus or display, a slidably adjustable flight seat for different sized pilots, one or more electric motor assemblies, and associated flying peripherals coupled with a computer. Peripherals for flight simulators may include: a flight yoke; flight stick controller; throttle; rudder pedals; and one or more instrument panels. Due to the multitude of airplanes, helicopters, jets, and other flying machines, the display, peripherals, motors and frame of flight motion simulators are usually built for one type of flight experience and synced to work exclusively with specific flight software.

It is believed that substantial differences in engineering, design, movement, and functionality of the frame, peripherals and seating positions have made it difficult to develop a multimodal simulator capable of providing realistic and immersive driving, flying and riding experiences. For example, an immersive jet ski simulator typically allows riders to straddle a seat fixed to a narrow simulator frame to allow users to grip the frame and lean into virtual turns by swaying their body weight from side to side, just as they would on a real jet ski. It is believed that this dynamic of providing realistic and immersive experiences is not possible in a flight simulator which requires a frame forming a cockpit that houses a pilot scat and peripherals such that they are positioned around the user's body.

The seating position in a flight or driving simulator cockpit or cabin will also hold the user in a different position than a saddle seat of any riding experience. Not only is the center of gravity of a riding position higher than that of a driving or flying position, but the user's body is positioned differently to accommodate the different movements and techniques required for riding. In a riding position, the rider is leaning forward into the handlebars of the device, with their legs straddling the seat and frame of the simulator, and extending downward and away from the handlebars toward the base of the simulator. This position permits the user to hold the frame under them and lean into turns to allow for physical immersion that matches their visual movements as they navigate in their immersive virtual experience. In a flying or driving position, the user's body is contained within the frame that forms a cockpit or cabin, is in an upright or slightly declined seated position leaning away from the steering wheel or yoke with their legs extending forward toward the front of the simulator and often under the steering mechanism. These differences in the physical positioning of the body make it difficult to have an immersive multimodal experience in a system that is built specifically for immersive riding, driving or flying experiences.

One reason fully immersive multimodal systems have not been developed is due to the numerous peripherals that are required for simulation of multiple vehicles. For example, current simulators that combine driving and flying experiences would require ten or more peripherals—most of which would need to occupy the same space—for a user to switch between simulated driving and flying experiences. To accommodate the required peripherals in a simulator that combined driving and flight experiences, a user would need to remove their VR display and physically detach the unwanted peripherals so that the desired peripherals could be attached in their place. Alternatively, if a user wanted to avoid swapping the peripherals, they could have two simulators, or alternatively one large simulator with two seats and two different sets of peripherals, to accomplish this goal. However, such a user could not maintain immersion in software that offers both flying and driving experiences if they need to physically relocate to a different simulator or seat.

Moreover, realistic and immersive simulators are often specifically engineered and programmed to work with dedicated single-experience simulation software. One reason for this is positioning of the user over the one or more electric motor assemblies that provide movement for the simulated experience. For example, if a car racing simulator is programmed for a user to be seated at a position of approximately ninety degrees over an electric motor assembly, that user will only feel the exact forces as programmed when seated in that exact position. If a taller or shorter user needs to adjust the seat to a different position that is not directly over the motor assembly, he or she will no longer experience the exact physical motion as programmed for the visual simulation. This can lead to feelings of limited immersion or vertigo. These feelings are only exacerbated when a simulator is tuned to multiple software applications offering multiple simulated experiences that will each have their own telemetry data, motion requirements and other immersion variables. The more discordant these variables, the more difficult it becomes to adjust the motion of the simulator to produce the most immersive and enjoyable experience for individual users.

There is a need for multimodal systems that deliver realistic and immersive experiences without requiring a user to attach and detach dedicated seats and peripherals from the frame and platform systems to engage different kinds of simulated experiences. There is an additional need to deliver these different simulations without requiring a user to disrupt their immersion by requiring them to physically exit the simulator or otherwise leave the virtual experience.

### SUMMARY

In accordance with an embodiment, a convertible seat assembly includes a seat bottom having a longitudinal axis, a top surface, a bottom surface, a first side, and a second side opposite the first side. The convertible seat assembly also includes a first side component disposed on the first side of the seat bottom, the first side component having a first planar surface, wherein the first side component is configured to move between a folded position and an unfolded position, wherein the first planar surface of the first side component is substantially parallel to the top surface of the seat bottom when the first side component is in the folded position, wherein the first side component is adjacent the bottom surface of the seat bottom when in the unfolded position, wherein the first side component rotates up to one hundred eighty (180) degrees around the longitudinal axis of the seat bottom when moving between the folded and unfolded positions, and a second side component disposed on the second side of the seat bottom, the second side component having a second planar surface, wherein the second side component is configured to move between a folded position and an unfolded position, wherein the second planar surface of the second side component is substantially parallel to the top surface of the seat bottom when the second side component is in the folded position, wherein the second side component is adjacent the bottom surface of the seat bottom when in the unfolded position, wherein the second side component rotates up to one hundred eighty (180) degrees around the longitudinal axis of the seat bottom when moving between the folded and unfolded positions. The convertible seat assembly is in a bucket configuration when the first and second side components are in the unfolded position. The convertible seat assembly is in a saddle configuration when the first and second side components are in the folded position. The convertible seat assembly may move between the bucket configuration and the saddle configuration while a user sits on the seat bottom.

In one embodiment, the first side components are attached to the seat bottom by a first plurality of hinges, and the second side components are attached to the seat bottom by a second plurality of hinges.

In another embodiment, the first plurality of hinges defines a second axis substantially parallel to the longitudinal axis of the seat bottom, and the second plurality of hinges defines a third axis substantially parallel to the longitudinal axis of the seat bottom.

In another embodiment, the convertible seat assembly also includes a slide device configured to raise and lower the seat bottom between a raised position and a lowered position.

In accordance with another embodiment, a multimodal simulation system includes a seat, a first peripheral device adapted to provide a first control function relating to a first simulation environment, a second peripheral device adapted to provide a second control function relating to a second simulation environment, and at least one moveable platform coupled to the first and second peripheral devices. The at least one moveable platform is adapted to move between a first position in which the first peripheral device is in a first in-use position and the second peripheral device is in a first stored position and a second position in which the first peripheral device is in a second stored position and the second peripheral device is in a second in-use position.

In one embodiment, the at least one movable platform includes at least one electric slide device.

In another embodiment, the first peripheral device includes a steering wheel and the second peripheral device includes one of a flight yoke, a throttle, and a rudder pedal.

### BRIEF DESCRIPTION OF THE DRAWINGS

The above objects and other advantages of the invention will become more readily apparent upon reading the following description and drawings, in which:

FIGS. 1A-B are front and back perspective views of an embodiment of a convertible seat in a bucket seat configuration for driving and flying.

FIGS. 2A-D are front, back, side, and partial top perspective views of an embodiment of the convertible seat in a saddle seat configuration for riding.

FIGS. 3A-C are top, bottom, and front views of an embodiment of the convertible seat base comprising a seat bottom coupled to left and right side seat components with hinges that can be rotated to convert the seat between driving and saddle scat configurations.

FIGS. 4A-C are front, top and side perspective schematics showing an exemplary mechanism of an embodiment of the convertible seat that converts by raising and lowering the seat position.

FIGS. 5A-B are front and side view schematics showing an exemplary mechanism of an embodiment of the convertible seat that converts by raising and lowering the seat position.

FIGS. 6A-D show an embodiment of the convertible seat that converts by raising and lowering the seat position that is held in a static position by an electric actuator to simulate the physical sensation of other types of seats, such as horse saddles.

FIG. 7 is a side view of a multimodal system comprising multiple peripherals that may be configured around a seat.

FIG. 8 is a perspective view of a multimodal system comprising multiple peripherals on moveable electric actuators that may be configured around a seat.

FIG. 9 is a cockpit view of a multimodal system comprising multiple peripherals on moveable electric actuators that may be configured around a seat.

FIG. 10 is a back view of a multimodal system comprising multiple peripherals on moveable electric actuators that may be configured around a seat.

FIG. 11 is a top rear body view of a multimodal system comprising a body, intelligent fans, vents, compartments, and display mounts configured around a seat.

FIG. 12 is a front view of an embodiment of a peripheral assembly that switches positions of driving pedal and rudder pedal peripherals by way of a pendulum optionally coupled to a rack and pinion stepper.

FIGS. 13A-13C show front, side and perspective views of a peripheral assembly that switches positions of driving, flying and riding peripherals by way of a rotary actuator, mounting plate, rotary plate, and forward/back and right/left linear slides.

FIGS. 14A-14D show perspective and side views of the peripheral assembly of FIGS. 13A-13C shown in flying and riding positions.

FIGS. 15A-15D show top, perspective, front, and side views of a peripheral assembly that switches positions of driving pedal and rudder pedal peripherals by way of a mounting plate and first and second electric slides.

### DETAILED DESCRIPTION

The examples and drawing provided in the detailed description are merely examples of embodiments and should not be used to limit the scope of the claims. Several embodiments of the claimed multimodal simulator systems may comprise motorized and configurable frames, platforms, chassis, and bodies, that may further be coupled with computers, software, displays and peripherals to provide immersive flying, driving, riding, and other experiences. Applicants disclose several preferred and alternative embodiments of multimodal systems with some preferred embodiments including peripherals on moveable platforms optionally coupled to actuators and electric slides that can be interchangeably configured around a convertible seat that is situated over one or more electric motor assemblies with multiple degrees of freedom. The one or more electric motor assemblies will preferably have up to six degrees of freedom which include surge, sway, heave, roll, pitch and yaw to deliver a wide variety of immersive experiences without requiring peripherals to be removed or the user to leave the immersive experience.

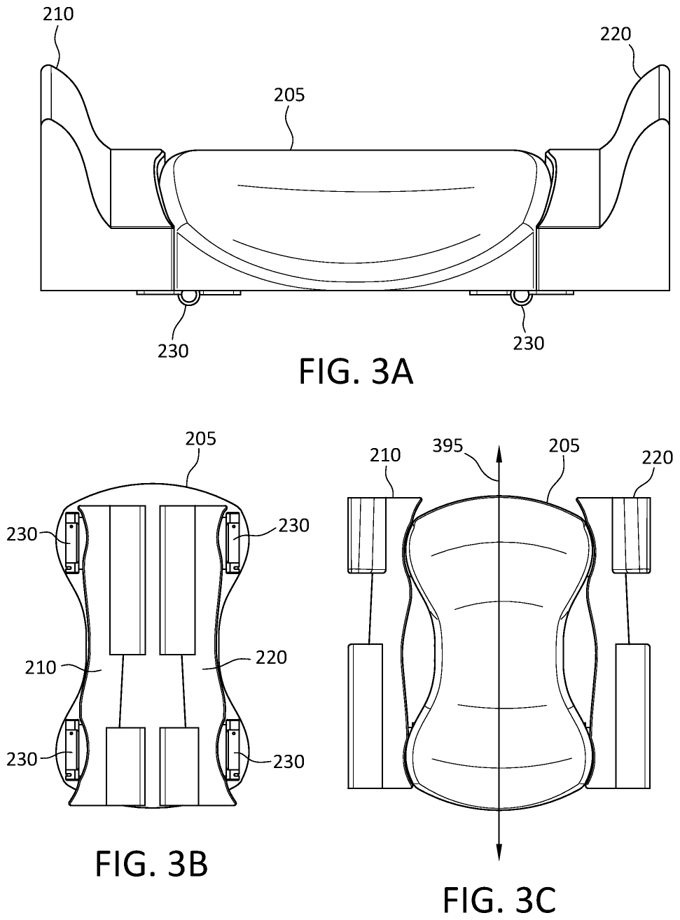

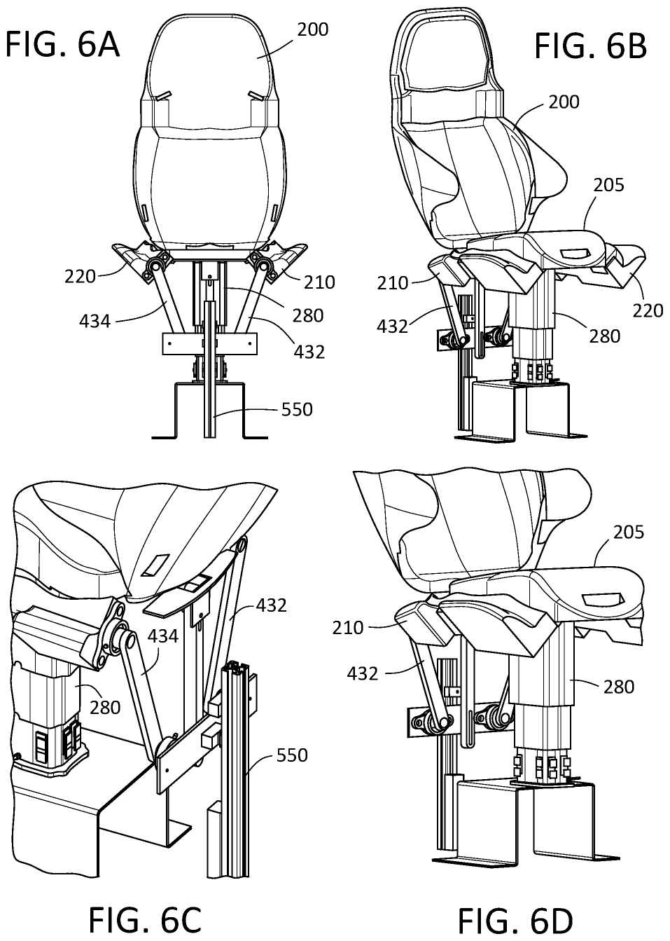

In some preferred embodiments, the multimodal simulator system may comprise a convertible seat that interchangeably converts from a car or pilot seat configuration, such as a bucket or racing seat, into a saddle seat configuration that may straddled, such as those found on bicycles, motorcycles, jet skis, ATVs, snow mobiles, horseback riding, and other vehicles that users may ride. In some embodiments, left and right-side components of a convertible scat arc removably attached to a seat bottom, and can be manually removed or replaced to create saddle seat and bucket seat configurations. In preferred embodiments, the left and right-side components are attached to the seat and can be rotated from a fully extended bucket seat configuration to a fully folded saddle seat configuration. See FIGS. 3A-3C., for example For example, some preferred embodiments of a convertible seat permit conversion of the seat into intermediate static configurations between the unfolded bucket seat and fully folded saddle seat configurations. For example, such an intermediate static configuration may comprise a widened saddle configuration to mimic horseback riding. In some embodiments, the convertible seat may be interchangeably converted between multiple configurations including a bucket seat for driving and flying, a widened saddle seat for horseback riding, a narrowed saddle seat for jet skiing, and a fully folded saddle seat for sport bike riding. The convertible seat can be held in any intermediate static position required for a specific immersive experience. The conversion can be performed manually or automatically through actuators and software. FIGS. 6A-6D show an embodiment of the convertible seat that can be held in an intermediate static position by an electric actuator.

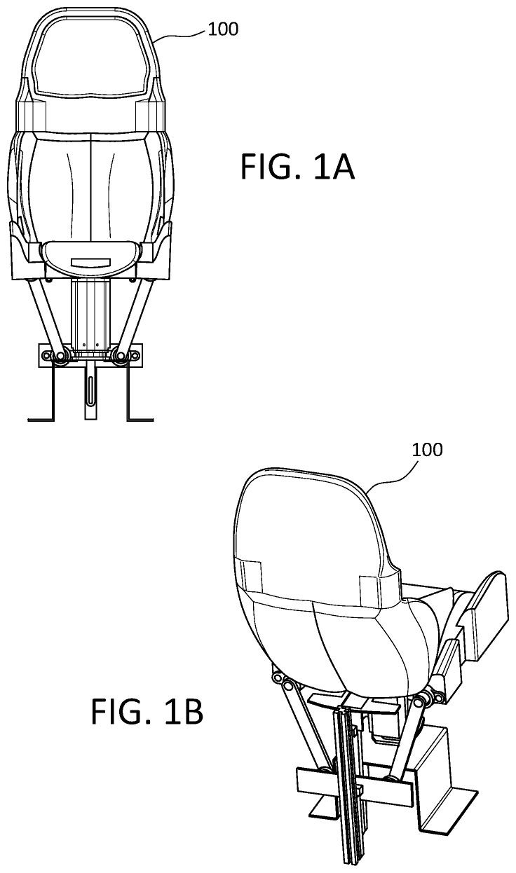

FIGS. 1A-1B show a seat 100 in accordance with an embodiment. FIG. 1A shows a front view of seat 100. FIG. 1B shows a perspective view of the back of seat 100.

A convertible seat assembly may comprise a seat bottom, seat back, headrest, reclining mechanism, cushioning, and bolstered side components (i.e., side bolsters) on the seat bottom and seat back to form a bucket seat. In some embodiments of the convertible seat assembly, the seat assembly may comprise a seat bottom with rotating left-side and right-side components that can be lowered to create a saddle seat configuration or raised to create a bucket seat configuration with the seat bottom. The user can straddle the saddle seat configuration to provide physically immersive riding experiences such as riding a motorcycle or jet ski. Some embodiments may optionally include bicycle pedals attached to the mounting plates 452 and 454 that may be reached when the seat is in the saddle configuration. The user can also sit in the bucket seat configuration to provide physically immersive driving/flying experiences such as driving a race car or flying a plane.

In preferred embodiments of the convertible seat, the seat has a seat bottom, and left-side and right-side components that are each coupled to the seat bottom by one or more hinges configured to allow the side components to rotate up to one hundred eighty (180) degrees relative to the longitudinal direction of the scat bottom. As shown in the drawings, the hinges can extend in a direction substantially parallel to the longitudinal direction of seat bottom allowing for the rotation of the side components. The hinges allow the side components (e.g., the side bolsters) to be easily lowered or raised between a folded saddle seat configuration and an unfolded bucket seat configuration.

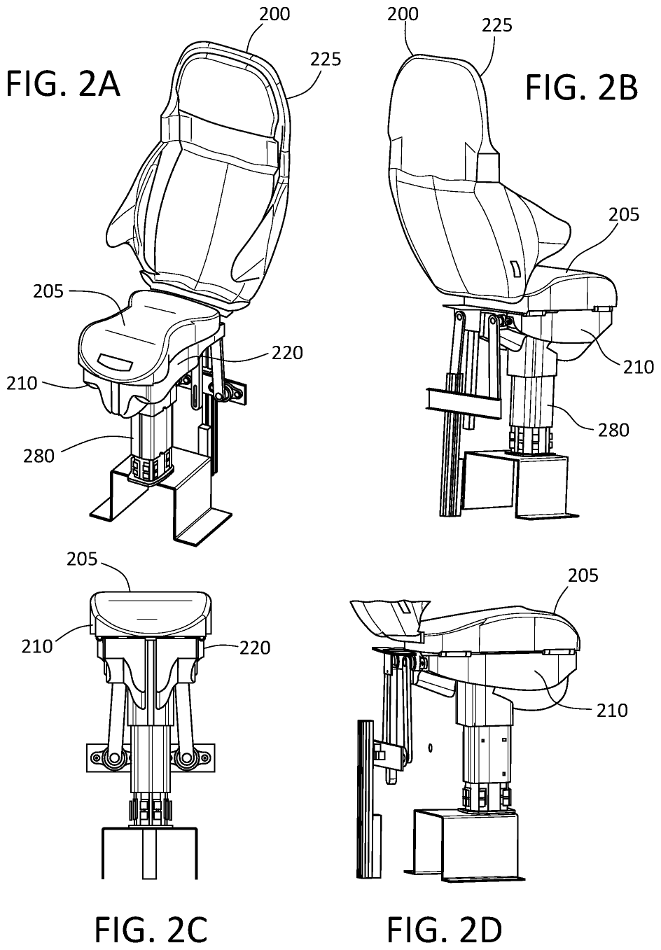

FIGS. 2A-2D show a seat 200 in accordance with another embodiment. FIG. 2A shows a perspective view of the front of seat 200. FIG. 2B shows a perspective view of the back of seat 200. Seat 200 includes a seat bottom 205, a seat back 225, a right-side component 210, a left-side component 220, and a slide device 280. Right-side component 210 and left-side component 220 have folded and unfolded positions. In FIGS. 2A-2D, right-side component 210 and left-side component 220 are in the folded position. Slide device 280 is configured to cause seat bottom 205 to move up and down between a raised position and a lowered position.

FIGS. 3A-3C show convertible scat 200 without scat back 225 and slide device 280. More particularly, FIGS. 3A-3C show movement of the right-side and left-side components as they rotate between the folded and unfolded positions, which provide the saddle and bucket seat configurations, respectively, in accordance with several embodiments of the invention.

FIG. 3A shows a front view of a seat bottom 205, a right-side component 210, and a left-side component 220 in the unfolded position thereby providing the bucket seat configuration. As shown in FIG. 3A, right-side component 210 and left-side component 220 are coupled to the bottom surface (not labelled) of seat bottom 205 by a respective set of hinges 230. In various embodiments, each side component may be attached to seat bottom 230 by a single hinge or by a plurality of hinges.

Longitudinal axis 395 of seat bottom 205 is shown in FIG. 3C.

In FIG. 3A, right-side component 210 and left-side component 220 are shown raised to convert seat 200 into the unfolded (i.e., extended) position thereby providing the bucket seat configuration. As shown in FIG. 3A, each set of hinges 230 is oriented to define an axis that is substantially parallel to the longitudinal direction seat bottom 205, thereby allowing side components 210, 220 to rotate up to one hundred eighty (180) degrees around the longitudinal axis of seat bottom 205 when transitioning between the unfolded and folded positions of convertible seat 200.

More specifically, each side component 210, 220 is attached to seat bottom 205 by a set of hinges 230 (i.e., the hinge or hinges attached to a respective side component). Each set of hinges defines an axis substantially parallel to the longitudinal axis of the seat bottom 205. As each side component 210, 220 moves between the folded and unfolded positions, the side component rotates up to one hundred eighty (180) degrees around the respective hinge axis.

FIG. 3B shows a bottom plan view of seat bottom 205 when seat 200 is in the folded position. In FIG. 3B, right side component 210 and left side component 220 are in the folded position and positioned underneath seat bottom 205 due to the rotation provided by hinges 230.

FIG. 3C shows a top plane view of seat bottom 205 with right-side component 210 and left-side component 220 in the unfolded (i.e., extended) position as originally show in FIG. 3A. Longitudinal axis 395 of seat bottom 205 is shown. As explained above, each side component 210, 220 is attached to seat bottom by a corresponding set of hinges 230 and is configured to rotate around an axis defined by the corresponding set of hinges (hinges 230 are not shown in FIG. 3C). The hinge axis is substantially parallel to longitudinal axis 395 of scat bottom 205.

To convert between the bucket and saddle seat configurations, the hinged side components 210, 220 can be moved to a position where the planar surfaces (not labelled) of side components 210, 220 are substantially parallel to the top surface (not labelled) of seat bottom 205 providing the bucket seat configuration or to position under the bottom surface (not labelled) of seat bottom 205 providing the saddle seat configuration. A distinct advantage of the convertibility of seat 200 is that a user does not have to dismount seat 200 as seat 200 transitions between the two (2) different configurations of the claimed invention.

Some preferred embodiments of the convertible seat may comprise hinged left-side and right-side components of the seat base that are coupled to actuators by one or more bar linkages that allow the side components to rotate into a position under the bottom surface of seat bottom 205. The one or more bar linkages support the side components of the seat in both the bucket seat and saddle seat configurations to support the weight of the user and the physical forces of the multimodal simulator while in operation. The one or more bar linkages may be attached to spherical bearings allowing the side components to turn freely around the hinge point. The convertible seat may be moved or constrained by attachment of the one or more bar linkages to bearings that may be coupled to an electric slide device and actuator.

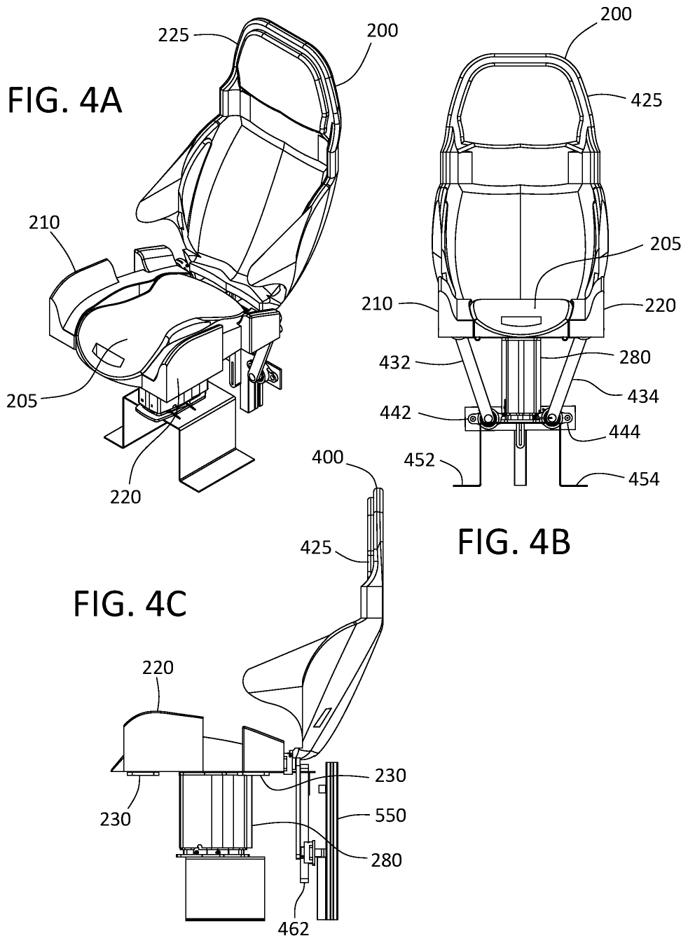

FIG. 4A shows a perspective view of seat 200. FIG. 4B shows a front view of seat 200. FIG. 4C shows a left side view of seat 200.

Referring to FIGS. 4A-4C, scat 200 includes scat bottom 205, scat back 225, right-side component 210, left-side component 220, a right-side bar linkage 432, a left-side bar linkage 434, lower spherical bearings 442 and 444, mounting plates 452 and 454, hinges 230, and a connecting linkage 462.

Right-side bar linkage 432 is coupled to and controls the movement of right-side component 210. Left-side bar linkage 434 is coupled to and controls the movement of left-side component 220. Right-side bar linkage 432 is coupled to right-side spherical bearing 442 and right-side mounting plate 452. Left-side bar linkage 434 is coupled to left-side spherical bearing 444 and left-side mounting plate 454.

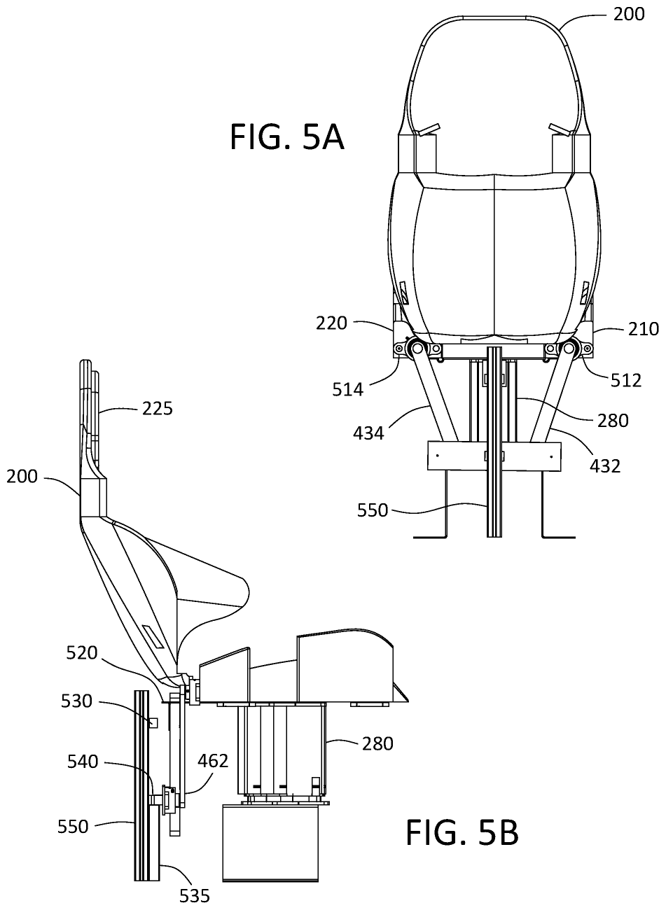

Referring to FIG. 5A, seat 200 includes upper spherical bearings 512, 514. Upper spherical bearing 512 is coupled to right-side component 210. Upper spherical bearing 514 is coupled to left-side component 220. Bar linkage 432 is coupled to upper spherical bearing 512. Bar linkage 434 is coupled to upper spherical bearing 514.

Seat 200 includes slide device 280. Slide device 280 is configured to function as a lift mechanism and move seat bottom 205 (along with seat back 225, right-side component 210, and left-side component 220) up and down between a lowered position and a raised position. In one embodiment, slide device 280 operates based on electric power. In another embodiment, slide device 280 may be powered by a hydraulic mechanism or by another form of power.

Seat 200 also includes a T-Slot slider 540 and a T-Slot guide 550. T-Slot slider 540 is coupled to seat bottom 205 via a connecting linkage 462 and a coupling mounting plate 520. T-Slot guide 550 includes hard stops 530 and 535. T-Slot slider 540 is configured to move within T-Slot guide 550 between hard stops 530, 535. Thus, when slide device 280 causes seat bottom 205 to move up or down, T-Slot slider 540 moves correspondingly up or down within T-Slot guide 550. The presence of hard stops 530, 535 on T-Slot guide 550 imposes physical limits on the upward and downward movement of T-Slot slider 540, and therefore also limits the movement of seat bottom 205 to a defined range.

Depending on whether the actuator is activated, the electric lift (slide device 280) moves from a lowered position (as seen, for example, in FIGS. 4A-4C) to a raised position (as seen, for example, in FIGS. 6A-6D). As a result of this movement, the electric lift (slide device 280) causes seat bottom to move from a lowered position (as seen, for example, in FIGS. 4A-4C) to a raised position (as seen, for example, in FIGS. 2A-2D). Also, the movement of the electric lift (slide device 280) may mechanically convert the seat into a saddle or driving seat configuration, or hold it in a static configuration for a wider saddle seat configuration to replicate the physical sensation of other types of riding seats, such as horse saddles. More specifically, as slide device 280 moves seat bottom 205 from the lowered to the raised position, bar linkages 432, 434 may cause right and left side components 210, 220, respectively, to move from a folded position to an unfolded position. FIGS. 6A-6D show seat 200 in a wide saddle seat configuration in accordance with an embodiment. In FIGS. 6A-6D, right-side and left-side components 210, 220 are in an unfolded position at the sides of seat bottom 205, providing a simulated experience of a horse saddle or other wide riding seat.

The convertible seat assembly may optionally be mounted to one or more electric motor assemblies providing physical motion in the multimodal simulator. The electric motor assemblies may incorporate one or more degrees of freedom including, for example, surge, sway, heave, roll, pitch and yaw. Preferred embodiments of multimodal systems will comprise electric motor assemblies having at least six degrees of freedom. In some embodiments, the convertible seat assembly may be coupled to the electric motor assembly by way of a column, and optionally one or more platforms coupled to the seat or the motor assembly at either end of the column, that raises the convertible seat when in the saddle seat configuration, and lowers the convertible seat when in the bucket seat configuration. By raising and lowering the seat, the position of the user in driving, flying and different riding experiences may be optimized for the best immersive experience.

In some embodiments, the position of the side components of the convertible seat may be controlled by raising and lowering the seat. In some preferred embodiments, the position of the one or more bar linkages with respect to the one or more electric slide devices affects the rotation of side components of the seat in predetermined and specified manner and may be controlled by the movement of the electric slide. In these embodiments, the movement of the side components of the convertible seat is realized by actuating the electric slide which translates into movement of the linkages and bearings that may be constrained to a predetermined distance. This constraint may include hard stops that compel the linkages to cease linear movement and allow for only rotational movement. This rotational movement is allowed by the bearings and translates into the hinging effect needed to move the left-side and right-side components simultaneously to attain the desired configuration of the convertible scat. In some embodiments, the configurations of the convertible seat may be controlled with the touch of a button, by voice command, or in an automated fashion without the user having to leave the seat or disrupt their immersive experience during conversion. In embodiments where the seat can convert with the user sitting in the seat, protective features may be added to the seat to ensure user safety. For example, some embodiments may comprise seat belts to keep the user in place during conversion. Embodiments may also comprise tapered or beveled edges on the seat to avoid pinching injuries, and optional one or more cutouts on the side and seat bottom of the seat base that have multiple functions including, for example, avoiding pinch injuries, allowing for more comfortable riding positions, allowing for efficient placement under the seat, and air circulation.

In some embodiments of multimodal systems, the convertible seat may be slidably adjustable forwards and backwards to accommodate users of different heights. However, moving the position of the user over the one or more electric motor assemblies is not optimal as it causes differentiations in simulated movements from user to user that affects the immersive quality of the virtual experience. For example, if a taller or shorter user needs to adjust the seat to a position that is not aligned with the position that the electric motor assembly was programmed for optimal movement simulation, he or she will not experience physical simulation that corresponds with their visual simulation. This can lead to feelings of limited immersion or vertigo as is often experienced in many simulators and VR devices. These feelings are only exacerbated when a simulator is tuned to multiple software applications offering multiple simulated experiences that will each have their own telemetry data, motion requirements and other immersion variables. The more discordant these variables, the more difficult it becomes to adjust the motion of the simulator to produce the most immersive and enjoyable experience for individual users.

In some preferred embodiments of multimodal systems, the seat is not slidably adjustable to maintain the x, y spatial orientation of the user in relation to the one or more electric motor assemblies of the multimodal simulator. In embodiments where the seat is not slidably adjustable, the frame or multiple peripherals on moveable platforms may be adjusted around the user to accommodate users of different heights and sizes. For example, in some embodiments the driving pedals and steering wheel peripherals of a car simulation may be slidably adjustable forwards and backwards and side to side on one or more moveable platforms to accommodate users of different heights. The convertible seat may also be raised and lowered to accommodate users of different heights. For example, if the convertible scat is in the saddle configuration for a motorcycle simulation, the seat may be raised for taller users and lowered for shorter users to maintain optimal immersion in the simulation.

Maintaining the convertible seat in a fixed position in an x, y axis in relation to the one or more electric motor assemblies allows for greater ease of programming the multimodal simulator. For example, by fixing the position of the seat, programming the movement of the simulator for any given simulation or experience is simplified in that it only needs to be optimized for one position of the fixed convertible seat as opposed to a range of positions in an adjustable seat. Another benefit of a fixed seating position is uniformity in user experience. For example, two users with extreme differences in height would experience remarkable differences in simulated motion in the same simulator and simulated experience due to the different positions of the slidably adjustable seat over the one or more electric motor assemblies. Fixing the seat in an x, y position over the electric motor assemblies allows for uniformity in user experience. Ease of programming together with uniformity of user experience allows for fast and efficient programming of physical motion that corresponds with a variety of different software and types of simulated experiences, including third party software and experiences not specifically created for use in a multimodal system.

Embodiments of the multimodal systems may incorporate several different types of peripherals contained in a small space. In some embodiments, all peripherals that would be required for driving, flying and riding experiences may be included within a single multimodal system. For example, one embodiment of a multimodal system comprises a frame with one or more electric motor assemblies, a convertible seat, a display such as a VR apparatus, and driving, riding and flying peripherals that may include: a steering wheel; a manual gear shift; an emergency brake or handbrake; driving pedals; handlebars with acceleration and brakes; motorcycle clutch pedals; a flight yoke; joystick; flight stick controller; throttle; rudder pedals; safety systems such as seat belts, emergency stop, and proximity lasers, and one or more instrument panels. In some preferred embodiments, one or more of the peripherals may be coupled to moveable platforms such that the peripherals may be optionally moved around the user so that the user does not have to physically remove the peripherals and attach new peripherals in their place to experience different simulations.

In various embodiments, a seat apparatus may include a seat and several peripherals.

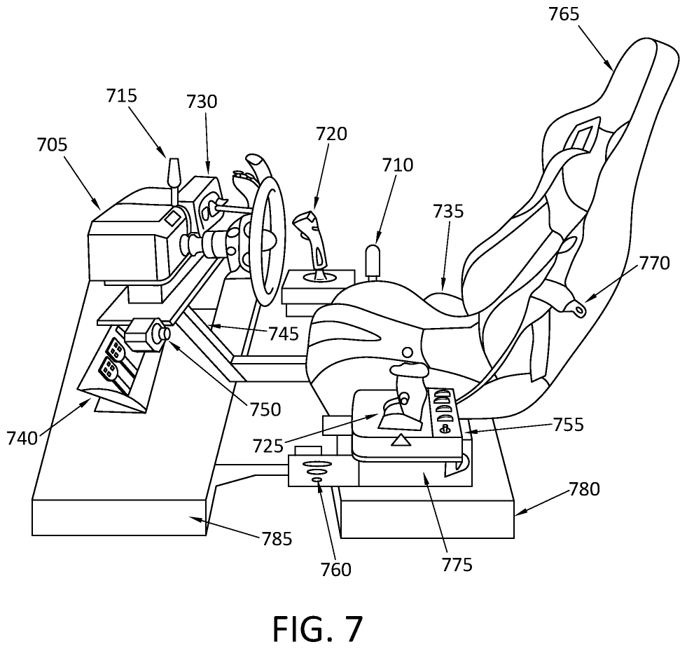

FIGS. 7-11 show examples of multimodal simulator systems incorporating multiple peripherals in accordance with various embodiments. FIG. 7 shows a side view of an embodiment of a multimodal system incorporating multiple peripherals that may be configured around a seat in accordance with an embodiment. The multimodal system includes a steering wheel 705, a shifter 710, a handbrake 715, a joystick 720, a left-hand throttle 725, a yoke 730, a right-hand throttle 735, driving pedals 740, rudder pedals 745, an emergency stop button 750, a left throttle actuator 755, a scent release dispenser 760, a seat 765, a seat belt 770, a seat motor 775, a rear base motor 780, and a front base motor 785.

In an illustrative embodiment, a user may sit in seat 765 and employ seat belt 770 during a simulation experience.

In one embodiment, various peripherals allow a user to control a vehicle within a simulation. Thus, for example, steering wheel 705 allows a user to control movement of a vehicle within a simulation. Shifter 710 may allow the user to shift gears within the simulation. Handbrake 715, joystick 720, left-hand throttle 725, yoke 730, right-hand throttle 735, driving pedals 740, rudder pedals 745, and left throttle actuator 755 may be used within various simulations to control aspects of a vehicle's movement and/or operation. Emergency stop button 750 may allow a user to stop the movement of a vehicle within a simulation or, alternatively, to stop the operation of a simulation itself. Scent release dispenser 760 may be used to provide one or more selected scents to enhance the user's simulation experience.

In one embodiment, seat motor 775, rear base motor 780, and front base motor 785 provide power to control movement of seat 765.

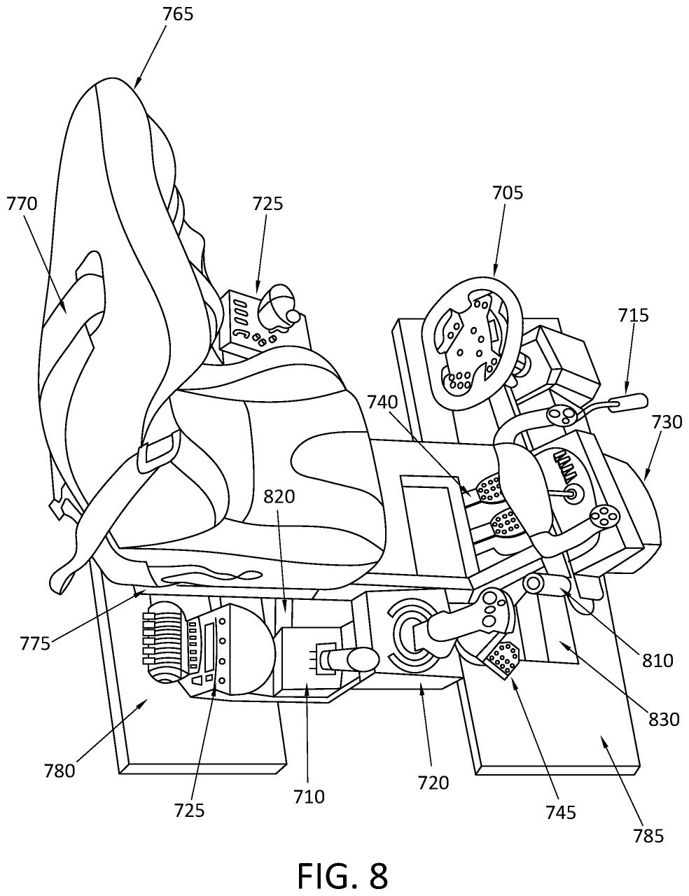

FIG. 8 is a perspective view of an embodiment of a multimodal system incorporating multiple peripherals on moveable electric actuators that may be configured around a seat in accordance with an embodiment. In addition to components shown in FIG. 7, a front actuator 810, a right peripherals actuator 820, and a pedals forward/back actuator 830 are visible in FIG. 8. Front actuator 810, right peripherals actuator 820, and pedals forward/back actuator 830 may be used by a user to control aspects of a vehicle or other object within a simulation.

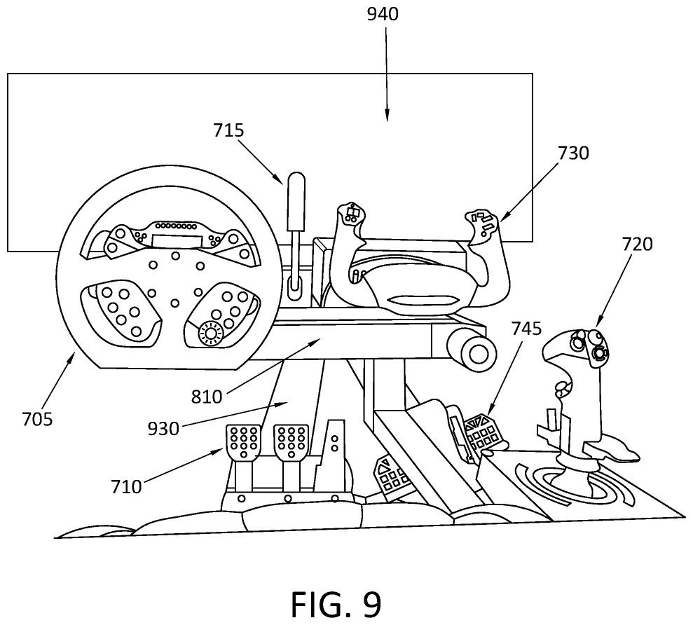

FIG. 9 is a cockpit view of an embodiment of a multimodal system incorporating multiple peripherals on moveable electric actuators that may be configured around a seat in accordance with an embodiment. A display 940 and a pedals pendulum frame and actuator 930 are visible in FIG. 9. Display 940 may display visual elements of a simulation.

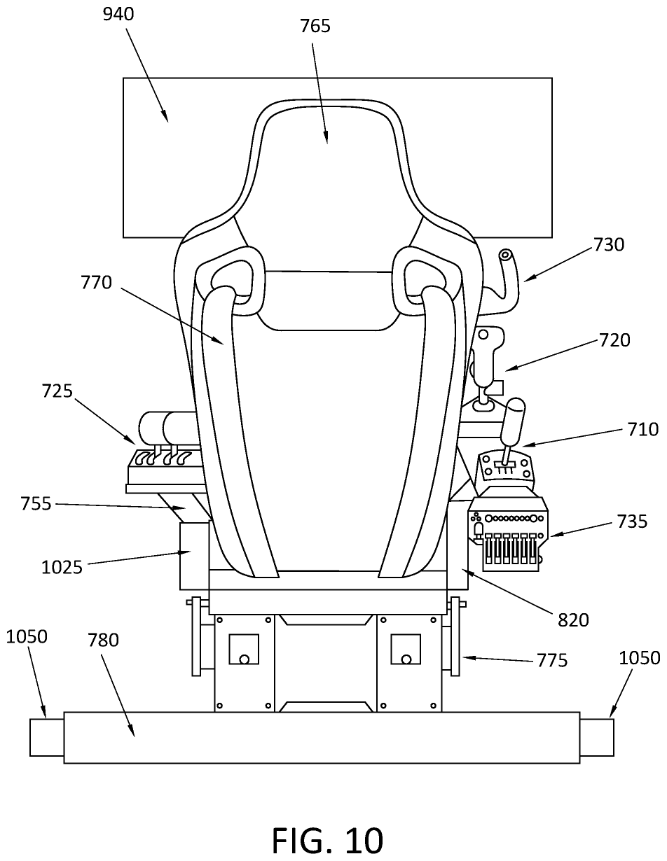

FIG. 10 is a view of the back of an embodiment of a multimodal system incorporating multiple peripherals on moveable electric actuators that may be configured around a seat in accordance with an embodiment. A seat forward/back actuator 1025 and safety proximity lasers 1050 are visible in FIG. 10. Seat forward/back actuator 1025 may be used to control the position of seat 765.

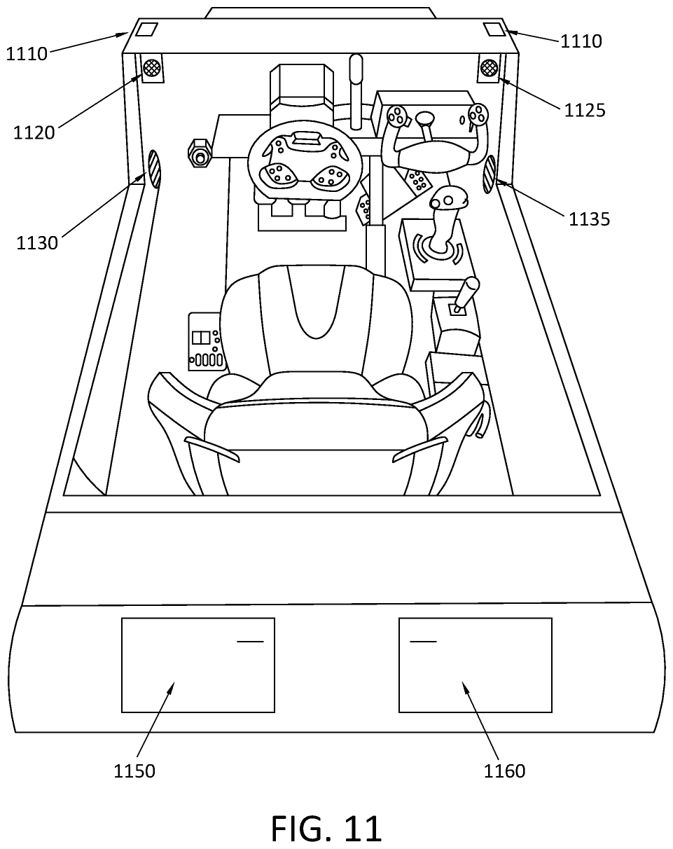

FIG. 11 is a top rear body view of an embodiment of a multimodal system incorporating a body, intelligent fans, vents, compartments, and display mounts configured around a seat in accordance with an embodiment. The system includes display mount holes 1110, a left-side intelligent fan 1120, a right-side intelligent fan 1125, a left-side cockpit cooling vent 1130, a right-side cockpit cooling vent 1135, a storage compartment and door 1150, and a refrigerator 1160. Display mount holes 1110 arc adapted to support a display such as display 940. Left-side intelligent fan 1120, right-side intelligent fan 1125, left-side cockpit cooling vent 1130, and right-side cockpit cooling vent 1135 are adapted to provide climate control of the user's environment.

In some preferred embodiments, one or more of the peripherals may be coupled to moveable platforms such that the peripherals may be optionally moved around the user so that the user does not have to physically remove the peripherals and attach new peripherals in their place to experience different simulations. Advantageously, in some preferred embodiments, the moveable platforms may be optionally coupled with actuators and electric slides that may be put into position for different driving, flying, and riding experiences automatically, for example, at the touch of a button or by voice command.

This, in accordance with one embodiment, a multimodal simulation system includes a seat, a first peripheral device adapted to provide a first control function relating to a first simulation environment, a second peripheral device adapted to provide a second control function relating to a second simulation environment, and at least one moveable platform coupled to the first and second peripheral devices. The at least one moveable platform is adapted to move between a first position in which the first peripheral device is in a first in-use position and the second peripheral device is in a first stored position and a second position in which the first peripheral device is in a second stored position and the second peripheral device is in a second in-use position.

For example, in one embodiment, a user may switch between flying and driving simulations in a multimodal system by adjusting the one or more moveable platforms holding the flight yoke, throttle, and rudder pedal peripherals away from the in-use positions, and adjusting the moveable platforms holding the steering wheel, manual gear shift, emergency brake or handbrake, and driving pedal peripherals toward the in-use positions. In some preferred embodiments, one or more of the moveable platforms are controlled with electric slides and actuators and may optionally be automated by voice command or push button control.

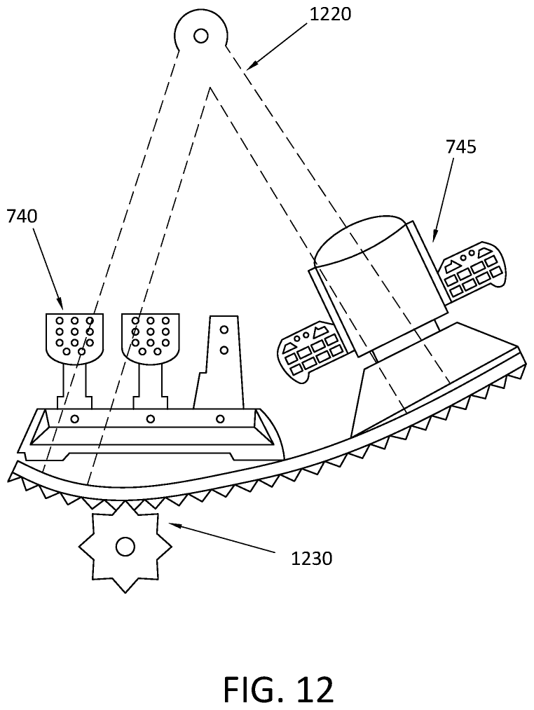

In several preferred embodiments, different combinations of peripherals may be moved to in-use positions through peripheral assemblies that may include one or more platforms coupled to one or more actuators and attaching two or more peripherals. Peripheral assemblies allow for more efficient use of space and a fewer number of required electric actuators, slides and other components required for movement. In some embodiments of peripheral assemblies, multiple peripherals can be coupled to one or more moveable platforms such that the peripherals move in unison when actuators are engaged. For example, one embodiment of a peripheral assembly may include driving pedal and rudder pedal peripherals coupled to a platform that may be moved by way of a pendulum and actuator, optionally paired to a rack and pinion stepper. FIG. 12 is a front view of a peripheral assembly that switches positions of driving pedal and rudder pedal peripherals by way of a pendulum optionally coupled to a rack and pinion stepper in accordance with an embodiment. The assembly includes a pendulum frame 1220, a rack & pinion stepper 1230, driving pedals 740, and rudder pedals 745.

To move the peripherals from side to side, a first electric slide may be actuated to place the appropriate peripheral in front of the seat for a given simulation. A second electric slide may be actuated to move the peripherals in directions distal and proximal to the seat (front/back directions) to adjust for users of different heights.

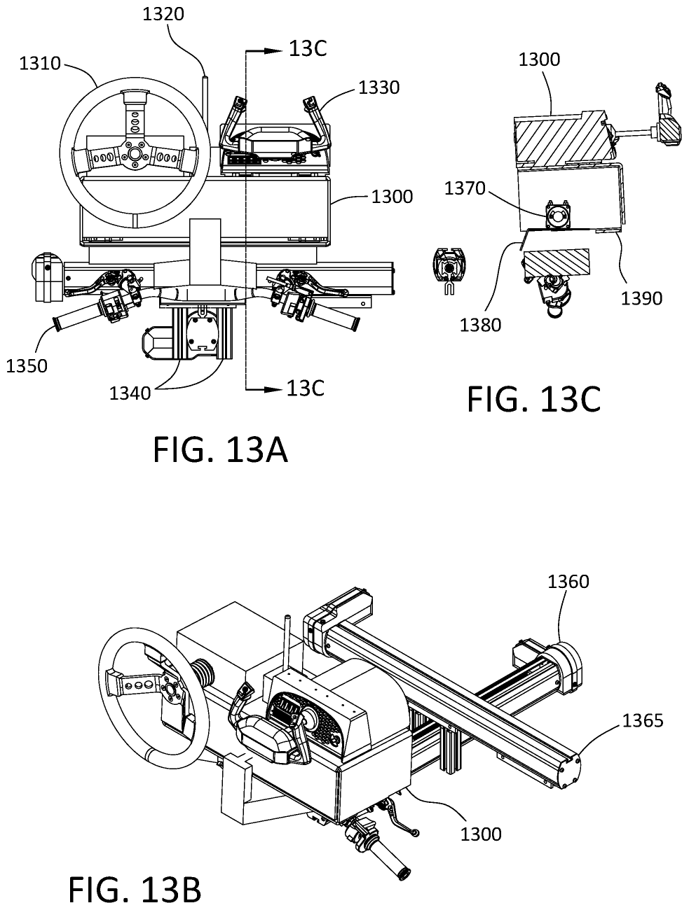

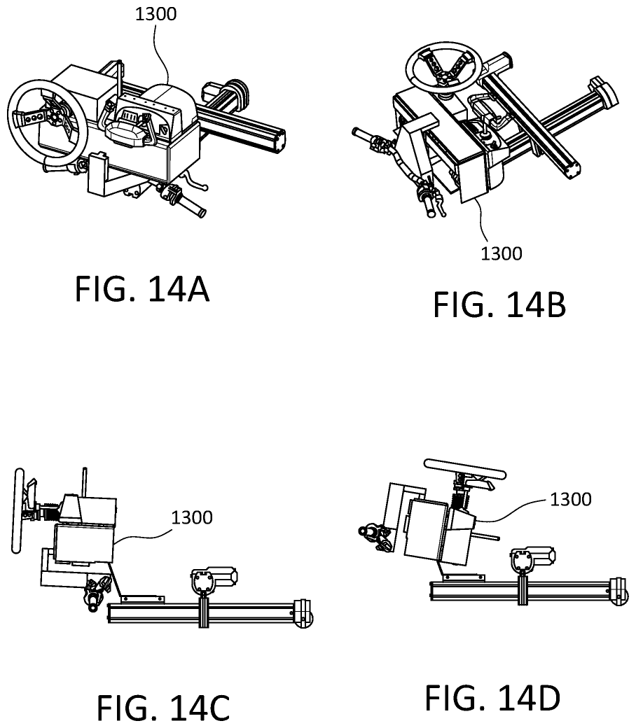

FIGS. 13A-13C and 14A-14D depict a peripheral assembly comprising mounting and rotary plates, a rotary actuator, linear slides, and four peripherals including a steering wheel, an emergency brake or handbrake, an airplane yoke, and handlebars in accordance with another embodiment. FIG. 13A shows a front view of the peripheral assembly 1300. FIG. 13B shows a perspective view of the front side of the peripheral assembly 1300. FIG. 13C shows a cross-sectional view of the peripheral assembly 1300 taken at line 13C-13C as shown in FIG. 13A. FIG. 14A shows a perspective view of the front side of the peripheral assembly 1300. FIG. 14B shows a perspective view of the back side of the peripheral assembly 1300. FIG. 14C shows a left-side view of the peripheral assembly 1300. FIG. 14D shows a right-side view of the peripheral assembly 1300.

The peripheral assembly includes a steering wheel 1310, an emergency brake 1320, an airplane yoke 1330, a T-slot attachment 1340, handle bars 1350, a forward/back linear slide 1360, a right/left linear slide 1365, a rotating actuator 1370, a mounting plate 1380, and a rotating plate 1390.

This peripheral assembly can move peripherals along multiple axes, including in x, y, z directions, to attain the proper position and distance from the seat. This exemplary embodiment provides multidirectional movement that allows the rider to switch between three types of vehicle modes—driving, flying and riding—and allows the user to personalize the positioning of the peripherals to optimize the simulation experience.

To move peripherals to a proper position and distance, one or more plates may be attached to one or more actuators and electric slides. Referring to FIGS. 13A-13C, mounting plate 1380 holding rotary actuators is mounted on an electric slide. A second rotating plate 1390 holding peripherals may be attached to the rotary actuators. To move the peripherals from side to side, right/left linear electric slide 1365 may be actuated, and to move the peripherals distal or proximal to the seat, forward/back linear electric slide 1360 may be actuated. Advantageously, a peripheral assembly including right/left linear electric slide 1365 allows a user to move several peripherals from side to side. For example, in some embodiments a user may be able to choose between driving and flight peripherals. T-Slot attachments 1340 may be used to attach the forward/back electric slide 1360 to the right/left linear electric slide 1365. This allows for an airplane yoke 1330, or alternatively a steering wheel 1310 and handbrake 1320, to be moved directly in front of the seat and at the appropriate distance for a given user sitting in the seat.

The embodiment of FIGS. 13A-13C also allows a user to switch from a driving or flying mode to a riding mode. The rotary actuation system of the peripheral assembly depicted in FIGS. 13A-13C may be activated to rotate the handlebars to position for bicycle, motorcycle, and other riding experiences. As with the driving and flying modes, the distance of the handlebars to the rider can be adjusted by both the actuator system and the second electric slide. In this embodiment, the driving and flying peripherals may be moved into a non-use position on top of the peripheral assembly as depicted in FIGS. 14A-14D, and optionally the convertible seat of the multimodal system may be raised and converted into a saddle scat configuration for use in a riding simulation.

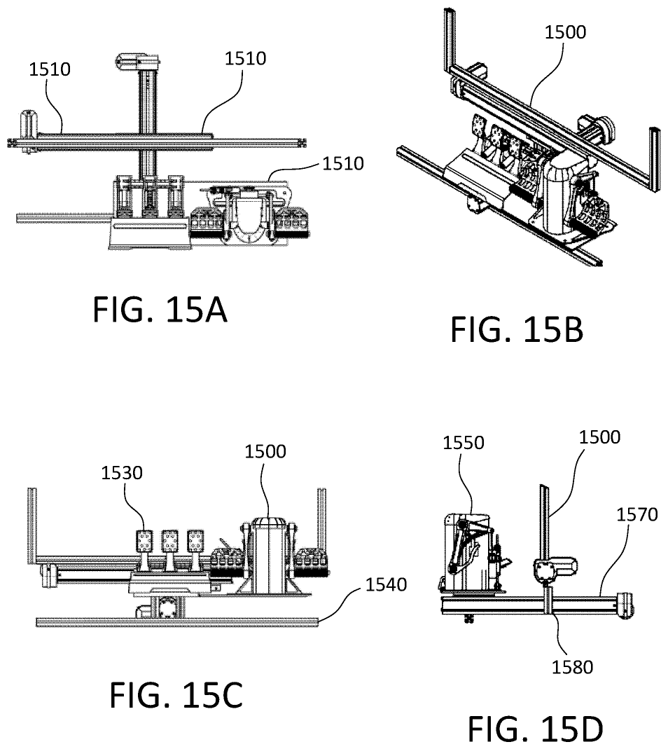

In other embodiments, driving, flying and riding peripherals may be included in a peripheral assembly that moves on multiple axes to place peripherals in usable positions with actuators, electric slides or other movement devices. Some peripheral assemblies may move peripherals into a usable position in front of the seat, and at a comfortable distance from a user when in use. For example, FIGS. 15A-15D depict an embodiment of a peripheral assembly holding driving and rudder pedal peripherals that controls both the position and distance of the peripherals in relation to the seat by way of a mounting plate and first and second electric slides. FIG. 15A shows a top view of peripheral assembly 1500. FIG. 15B shows a perspective view of the peripheral assembly 1500. FIG. 15C shows a front view of the peripheral assembly 1500. FIG. 15D shows a side view of the peripheral assembly 1500. The peripheral assembly 1500 shown in FIGS. 15A-15D includes a left/right linear slide 1510, a pedals/rudder mounting plate 1520, pedals 1530, a T-slot mounting 1540, a rudder 1550, a forward/back linear slide 1570, and T-slot attachments 1580.

An advantage of the presently disclosed embodiments of the multimodal system is the ability to experience different modes of travel in one simulator. Moreover, a user may experience multimodal simulation without interrupting immersion of the simulated experience by removing the VR apparatus, getting a tool kit, and physically removing and replacing peripherals needed for different experiences. Embodiments incorporating the convertible seat allows for seamless transition of driving and flying experiences to riding experiences. The conversion of the convertible seat, like the movement of the peripherals, can be accomplished without requiring the user to leave the immersion of their experience, or even leaving the seat during the conversion process. Other user senses may also be engaged for full immersion. For example, one or more embodiments (such as the embodiments of FIGS. 7 and 11, for example) may include intelligent electric fans and scent release dispensers that mimic the environment, speed and location of a user in a virtual environment. This allows for a fully immersive experience as a user switches from software application to application, or between different modes of travel within the same application.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. Those skilled in the art could implement various other feature combinations without departing from the scope and spirit of the invention. The claims are not limited by the preferred embodiments and examples but will cover many modifications and equivalents consistent with the written description as a whole.

We claim:

1. A convertible scat assembly comprising:
a seat bottom having a longitudinal axis, a top surface, a bottom surface, a first side, and a second side opposite the first side;
a first side component disposed on the first side of the seat bottom, the first side component having a first planar surface, wherein the first side component is configured to move between a folded position and an unfolded position, wherein the first planar surface of the first side component is substantially parallel to the top surface of the seat bottom when the first side component is in the folded position, wherein the first side component is adjacent the bottom surface of the seat bottom when in the unfolded position, wherein the first side component rotates up to one hundred eighty (180) degrees around the longitudinal axis of the seat bottom when moving between the folded and unfolded positions;
a second side component disposed on the second side of the seat bottom, the second side component having a second planar surface, wherein the second side component is configured to move between a folded position and an unfolded position, wherein the second planar surface of the second side component is substantially parallel to the top surface of the seat bottom when the second side component is in the folded position, wherein the second side component is adjacent the bottom surface of the seat bottom when in the unfolded position, wherein the second side component rotates up to one hundred eighty (180) degrees around the longitudinal axis of the seat bottom when moving between the folded and unfolded positions;
wherein:
the convertible seat assembly is in a bucket configuration when the first and second side components are in the unfolded position;
the convertible seat assembly is in a saddle configuration when the first and second side components are in the folded position;
the convertible seat assembly may move between the bucket configuration and the saddle configuration while a user sits on the seat bottom.

2. The convertible seat assembly of claim 1, wherein:
the first side components are attached to the seat bottom by a first plurality of hinges; and
the second side components are attached to the seat bottom by a second plurality of hinges.

3. The convertible scat assembly of claim 2, wherein:
the first plurality of hinges defines a second axis substantially parallel to the longitudinal axis of the seat bottom; and
the second plurality of hinges defines a third axis substantially parallel to the longitudinal axis of the seat bottom.

4. The convertible seat assembly of claim 1, further comprising a slide device configured to raise and lower the seat bottom between a raised position and a lowered position.

5. A multimodal simulation system comprising:
a seat;
a first peripheral device adapted to provide a first control function relating to a first simulation environment;
a second peripheral device adapted to provide a second control function relating to a second simulation environment; and
at least one moveable platform coupled to the first and second peripheral devices;
wherein the at least one moveable platform is adapted to move between a first position in which the first peripheral device is in a first in-use position and the second peripheral device is in a first stored position and a second position in which the first peripheral device is in a second stored position and the second peripheral device is in a second in-use position.

6. The multimodal simulation system of claim 5, wherein the at least one movable platform includes at least one electric slide device.

7. The multimodal simulation system of claim 5, wherein the first peripheral device includes a steering wheel and the second peripheral device includes one of a flight yoke, a throttle, and a rudder pedal.
